(19) United States
(12) Patent Application Publication
(10) Pub. No.: US 2013/0039107 A1
(43) Pub. Date: Feb. 14, 2013

(54) DISCHARGE CIRCUIT FOR CAPACITOR

(71) Applicant: Junichi FUKUTA, Anjo-shi (JP)

(72) Inventor: Junichi FUKUTA, Anjo-shi (JP)

(73) Assignee: DENSO CORPORATION, Kariya-city (JP)

(21) Appl. No.: 13/568,361

(22) Filed: Aug. 7, 2012

(30) Foreign Application Priority Data
Aug. 8, 2011 (JP) 2011-172551

(51) Int. Cl. H02M 7/537

(52) U.S. Cl. 363/131

(57) ABSTRACT

A discharge circuit for discharging a capacitor disposed in a power conversion circuit. The discharge circuit includes: a conduction path connecting the power conversion circuit and input terminals; plural resistors disposed in the conduction path, dividing voltage difference between voltage at the input terminal and reference voltage; a connection path connecting a pair of conduction paths; a switch disposed in the connection path, which opens and closes the connection path, the switch being controlled electrically; and a control unit that controls the switch to be opened or closed, the control unit controls the switch to be closed in order to make a closed loop circuit including the capacitor and the connection path. The connection path is disposed between the pair of conduction paths to include at least one resistor of the plurality of resistors in the closed loop circuit when the switch is closed by the control unit.

### CROSS-REFERENCE TO RELATED APPLICATION

This application is based on and claims the benefit of priorities from earlier Japanese Patent Application No. 2011-172551 filed on Aug. 8, 2011, the description of which are incorporated herein by reference.

### BACKGROUND

1. Technical Field

The present disclosure relates to discharge circuits and, more particularly to a discharge circuit for capacitors adapted to a system having a DC power source, a power conversion circuit and a voltage detecting circuit.

2. Description of the Related Art

Conventionally, the discharge circuit for capacitors has been widely used for a power conversion system. In the power conversion system, the DC power source is connected to the power conversion circuit via a pair of input terminals to which the capacitor is connected, and the voltage detecting circuit is connected to the pair of input terminals so as to detect voltage therebetween. For example, Japanese Patent Application Laid-Open Publication Nos. 2010-206909 and 2005-73399 disclose a power conversion system in which an inverter, a capacitor and a discharge resistor are connected in parallel to a battery that supplies power to a rotary electric machine as an on-vehicle main unit. Specifically, the capacitor (smoothing capacitor) disposed in the system includes a function that suppresses voltage variation between the pair of input terminals of the inverter. The discharge resistor forms a part of discharge circuit of the capacitor to discharge the capacitor while the battery and the inverter are disconnected by a switch disposed between the battery and the inverter.

However, when the discharge resistor is disposed in the above-described power conversion system, the number of components used for discharge circuit of the capacitor may increase. In this instance, size of the system may increase and the cost of the manufacturing the system may increase as well.

### SUMMARY

According to the present disclosure, an embodiment provides a discharge circuit of a capacitor that is capable of reducing the number of components.

As a first aspect of explanatory embodiment, a discharge circuit for discharging a capacitor is disposed in a system including a DC power source, a power conversion circuit and a voltage detecting circuit. The power conversion circuit is connected to the DC power source via a pair of input terminals included in the power conversion circuit. The capacitor is connected to the pair of input terminals and the voltage detecting circuit detects voltage between the pair of input terminals. The discharge circuit includes: a pair of conduction paths that connect between the power conversion circuit and the pair of input terminals; a series-connected resistor having a plurality of resistors connected in series, disposed in the conduction path, dividing a voltage difference between the input terminal and a reference voltage; a connection path that connects between the pair of conduction paths; a switch disposed in the connection path, which opens and closes the connection path, the switch being controlled electrically; and a control unit that controls the switch to be opened or closed, the control unit controlling the switch to be closed so as to make a closed loop circuit including the capacitor and the connection path. The connection path is disposed between the pair of conduction paths to include at least one resistor of the plurality of resistors in the closed loop circuit when the switch is closed by the control unit.

According to the above-described embodiment, the system includes a voltage detecting circuit in which voltage difference between voltage at the input terminal and the reference voltage is divided by the above-described series-connected resistor having a plurality of resistors, and the voltage between the pair of input terminals of the power conversion circuit is detected based on the divided voltage. Further, the system includes a connection path that connects between a pair of conduction paths (as described above configuration), a switch disposed in the connection path, and a control unit that controls the switch. Here, when the switch is controlled to be closed, a closed loop circuit including the capacitor, resistors and the connection path is formed. Therefore, the capacitor can be discharged with the resistors included in the voltage detecting circuit. Thus, according to the above-described configuration, since the resistors included in the voltage detecting circuit can be used as a discharge resistor, the number of circuit components necessary for the capacitor discharging circuit can be reduced. As a result, size of the system including the discharge circuit can be reduced. Also, increasing manufacturing cost can be suppressed.

As a second aspect of explanatory embodiment, the connection path is disposed in the pair of conduction paths such that total resistance value of the at least one resistor of the plurality of resistors included in the closed loop circuit is smaller than the total resistance value of the plurality of resistors of the series-connected resistor.

According to the above-described embodiment, the connection path is connected in the pair of conduction paths with the above-described configuration. Hence, the capacitor can be discharged immediately after a conduction path between the DC power source and the power conversion circuit is cutoff.

As a third aspect of explanatory embodiment, the power conversion circuit includes a boost converter that boosts voltage at the DC power source connected thereto and outputs the voltage boosted by the boost converter and a DC to AC converting circuit connected to an output of the boost converter, the capacitor is connected individually between the pair of input terminals disposed in the boost converter and the pair of input terminals disposed in the DC to AC converting circuit, and the voltage detecting circuit is arranged to be connected to both the boost converter and the DC to AC converting circuit individually.

According to the above-described embodiment, a boost converter and a DC to AC converting circuit are included in the power conversion circuit and capacitors are electrically connected to the respective pair of input terminals of the boost converter and the DC to AC converting circuit individually so as to suppress voltage variation between the pair of input terminals. Moreover, the voltage detecting circuits are arranged individually for the boost converter circuit and the DC to AC converting circuit to detect the voltage between the pair of input terminals of the boost converter and the DC to AC converting circuit. Therefore, in the above-described configuration, the resistors included in the voltage detecting circuits corresponding to the boost converter and the DC to AC converting circuit can be used for discharge resistors of the capacitors corresponding to the respective boost converter and the DC to AC converting circuit. Hence, the capacitors connected individually to the pair of input terminals of the respective boost converter and the DC to AC converting circuit can be discharged quickly.

As a fourth aspect of explanatory embodiment, the power conversion circuit includes a boost converter that boost voltage at the DC power source connected thereto and outputs the voltage boosted by the boost converter; and a DC to AC converting circuit connected to an output of the boost converter, the capacitor is connected individually between the pair of input terminals disposed in the boost converter and the pair of input terminals disposed in the DC to AC converting circuit, and the voltage detecting circuit is arranged to be connected to both the boost converter and the DC to AC converting circuit individually.

According to the above-described embodiment, when the power conversion system is in a faulty condition so that the control unit cannot output the operation signal, the switch is set to the closed state. Therefore, even when the power conversion system is faulty, discharging paths of the respective capacitors can be secured appropriately.

According to the above-described embodiment, during the power conversion system being operated in normal condition, the control unit outputs the operation signal to control the switch to be opened. Therefore, it is unnecessary to set the circuit into closed loop state during normal operation. As a result, since the closed loop circuit is not configured all the time, power consumption due to current flowing from the DC power source to the resistors in the above-described closed loop can be prevented, and heat generated by the resistors can be suppressed as well.

### BRIEF DESCRIPTION OF THE DRAWINGS

In the accompanying drawings:

FIG. 1 is a block diagram showing a system configuration according to the first embodiment of the present disclosure;

FIG. 2 is a diagram showing characteristics of a switching element of the first embodiment;

FIG. 3 is a diagram showing circuit configuration when the capacitor is discharged;

FIG. 4 is a diagram showing layout of the discharge resistor disposed on the circuit board according to the first embodiment; and

FIG. 5 is a block diagram showing a system configuration according to the second embodiment.

### DETAILED DESCRIPTION OF THE PREFERRED EMBODIMENTS

### First Embodiment

With reference to the drawings, hereinafter will be described a discharge circuit of a capacitor adapted to a power conversion system disposed in a parallel series hybrid vehicle according to the first embodiment.

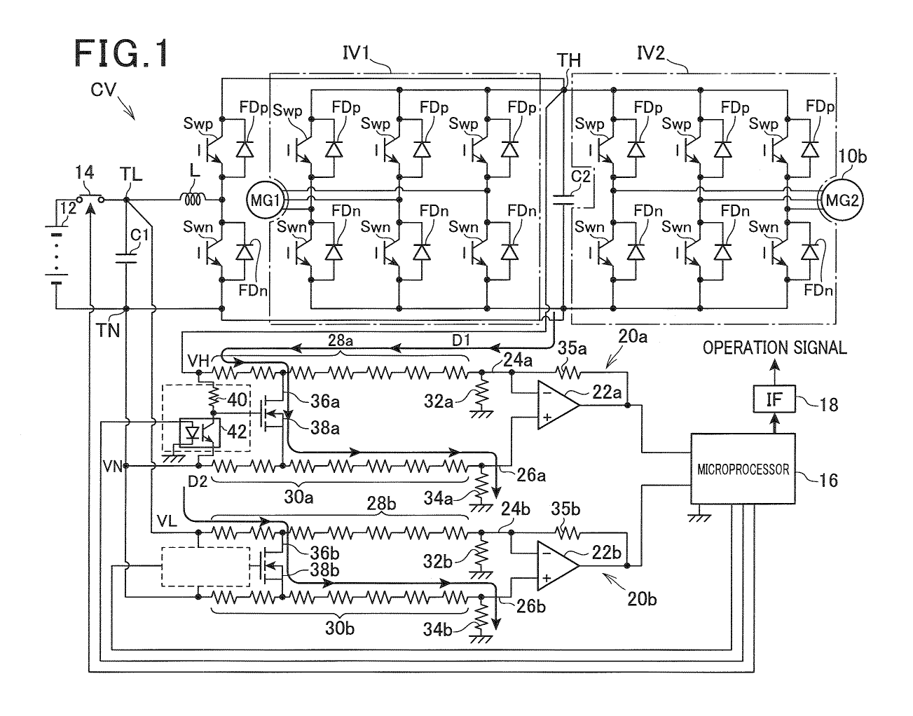

FIG. 1 is a system configuration according to the first embodiment.

A first motor generator 10a and a second motor generator 10b as shown in FIG. 1 are mechanically connected to the driving wheel and the internal combustion engine via a power splitter (not shown). The first motor generator 10a is electrically connected to an inverter IV1 and the second motor generator 10b is electrically connected to an inverter IV2. These inverters IV1 and IV2 are configured to receive the output voltage of a boost converter CV which boosts the voltage of the high voltage battery 12.

The high voltage battery 12 is a secondary battery having the terminal voltage 100 volts or more, ex, 280 volts. A lithium-ion battery, nickel-metal hydride battery can be used for the high voltage battery 12.

At the pair of input terminals of the boost converter CV, a capacitor C1 (smoothing capacitor) which suppresses voltage variation of the input voltage outputted by the high voltage battery 12 is connected.

The boost converter CV includes a series-connected body, a capacitor C2 (smoothing capacitor) connected in parallel to the series-connected body and an inductor L. The series-connected body includes a high side switching element Swp and a low side switching element Swn (i.e., switching means). The capacitor C2 suppresses voltage variation of the output voltage outputted to the inverters IV1 and IV2. The inductor L connects a connection point between the high side switching element Swp and the low side switching element Swn, and the high voltage battery 12. The boost converter CV operates the switching elements whereby the DC voltage of the high voltage battery 12 is boosted to a predetermined DC voltage as a upper limit voltage, e.g. 650 volts.

The above-described inverters IV1 and IV2 each include three internally series-connected bodies each having a high side switching element and a low side switching element (Le., switching means). The three series-connected bodies are connected in parallel each other. These connection points between switching elements Swp and Swn are connected to respective phases of the first motor generator 10a or the second motor generator 10b. Moreover, freewheel diodes FDp and FDn are connected in parallel to be in the reverse direction between the input terminal and the output terminal (i.e., between collector and emitter) of the respective high side switching elements and low side switching elements.

A relay 14 is disposed between the high voltage battery 12 and the boost converter CV so as to conduct and cutoff therebetween. According to the first embodiment, insulated bipolar transistor (IGBT) is used for the above-described switching elements Swp and Swn. Further, temperature sensing diodes are disposed closely to the switching element Swp and Swn to detect the temperature thereof (Not shown).

A microprocessor 16 is disposed in the power conversion system. The microprocessor 16 serves as a control unit (i.e., control means) that operates the above-described inverters IV1 and IV2 so as to control a control object of the first motor generator 10a and the second motor generator 10b (e.g. torque). The microprocessor 16 operates the switching elements Swp and Swn of the boost converter CV to control the output voltage of the boost converter CV. Specifically, the microprocessor 16 outputs an operation signal to the respective switching elements Swp and Swn of the inverter IV1 and IV2 and the boost converter CV via an interface 18 that includes insulating device such as a photo coupler, thereby controlling the inverters IV1 and IV2 and the boost converter CV. The interface 18 including the insulating device is provided to isolate the on-vehicle high voltage system including the inverters IV1 and IV2 and the high voltage battery 12 from an on-vehicle low voltage system including the microprocessor 16.

The microprocessor 16 reads input voltages of the boost converter CV and the inverters IV1 and IV2 when the microprocessor generates the above-described operation signals. For having the microprocessor 16 read the input voltages, a differential amplifier 20a converts the input voltage of the inverters IV1 and IV2 to be within the allowable input voltage range of an analog-digital converter included in the microprocessor 16 and a differential amplifier 20b converts the input voltage of the boost converter CV to be within the allowable input voltage range of the analog-digital converter.

These differential amplifiers 20a and 20b both include a function that converts the voltage of the pair of input terminals to a voltage with respect to the ground potential of the low voltage system which includes the microprocessor 16. According to the embodiment, since the ground potentials of the high voltage system and the low voltage system are different, the function for converting the voltage of the pair of input terminals to be with respect to ground potential of the low voltage system is necessary. Specifically, voltage at the negative input terminal of the boost converter CV and the inverter INV1 and INV2 (negative terminal of the capacitor C1) which is voltage VN at the negative input terminal TN is lower than the ground potential of the low voltage system. This is because, according to the embodiment, the ground potential of the low voltage system is with respect to a center value between the positive potential of the capacitor C1 and the negative potential of the capacitor C1. The ground potential of the low voltage system is produced such that voltage at both terminal of the capacitor C1 is divided by resistors to be the ground potential of the low voltage system. It is noted that the ground potential of the low voltage system is a potential of the body (body-potential).

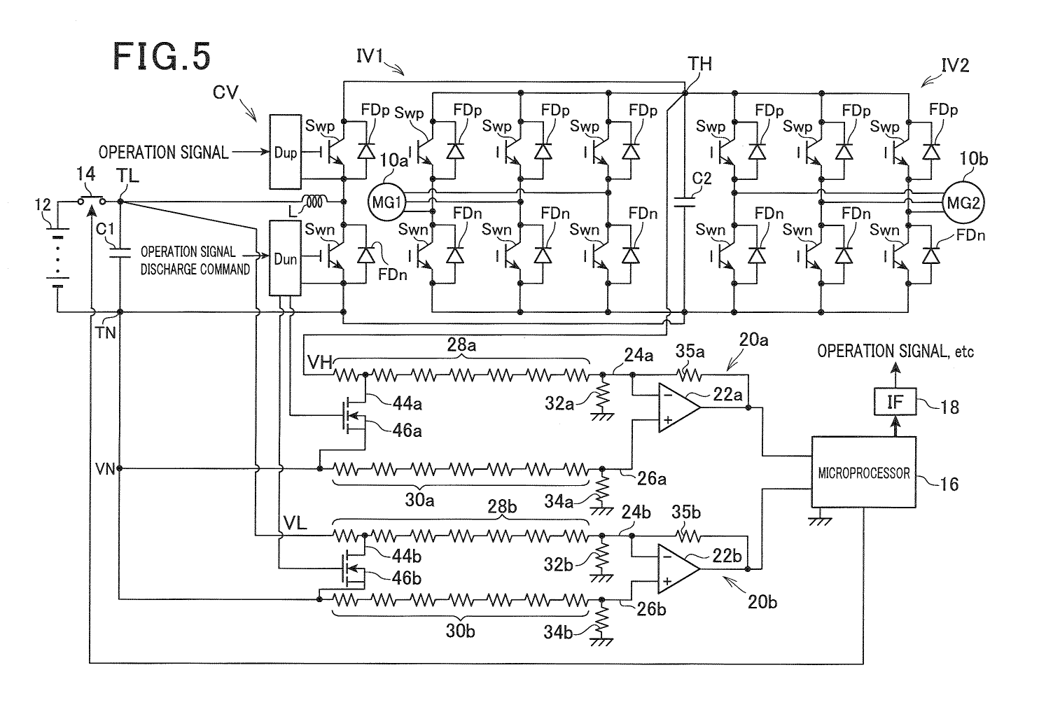

The positive input terminal of the inverters IV1 and IV2 (positive terminal of the capacitor C2) which is a positive input terminal (after boosting voltage) TH and an inverting input terminal of an operational amplifier 22a included in the differential amplifier circuit 20a are connected with a conduction path 24a, and the negative input terminal TN and a non-inverting input terminal of the operational amplifier 22a are connected with a conduction path 26a. Each of the conduction paths 24a and 26b includes a high-resistance resistor 28a and a high-resistance resistor 30a each having a plurality of high-resistance resistors connected in series (seven resistors are exemplified in FIG. 5).

The differential amplifier 20a converts a voltage difference between voltage VH at the positive input terminal TH and voltage VN at the negative input terminal TN. The voltage difference between the voltage VH at the positive input terminal TH and the ground potential is divided by the resistor 28a and a low-resistance resistor 32a and the voltage divided by the resistors 28a and 32a is applied to the inverting input terminal of the operational amplifier 22a. The voltage difference between the voltage VN at the negative input terminal TN and the ground potential is divided by a resistor 30a having a plurality of high-resistance resistors and a low-resistance resistor 34a and the voltage divided by the resistors 30a and 34a is applied to the non-inverting input terminal of the operational amplifier 22a. It is noted that a resistor 35a is connected between the inverting input terminal and the output terminal of the operational amplifier 22a.

Meanwhile, a battery positive input terminal TL which is a positive input terminal of the boost converter CV and the inverting input terminal of the operational amplifier 22b included in the differential amplifier 20b are connected with the conduction path 24b. Similarly, the negative input terminal TN and the non-inverting input terminal of the operational amplifier 22b are connected with the conduction path 26b. Moreover, in the conduction paths 24b and 26b, high-resistance resistors 28b and 30b (i.e., series-connected resistors) are disposed respectively. It is noted that the high-resistance resistors 28b and 30b each includes a plurality of resistors connected in series (seven resistors are exemplified in FIG. 1).

The differential amplifier 20b converts voltage difference between voltage VL at the battery positive input terminal TL and voltage VN at the negative input terminal TN. The voltage difference between the voltage VL at the battery positive input terminal TL and the ground potential is divided by the resistor 28b and a low-resistance resistor 32b and the voltage divided by the resistors 28b and 32b is applied to the inverting input terminal of the operational amplifier 22b. The voltage difference between the voltage VN at the negative input terminal TN and the ground potential is divided by a resistor 30b having a plurality of high-resistance resistors and a low-resistance resistor 34b and the voltage divided by the resistors 30b and 34b is applied to the non-inverting input terminal of the operational amplifier 22b. It is noted that a resistor 35b is connected between the inverting input terminal and the output terminal of the operational amplifier 22b.

According to the embodiment, the number of resistors that constitutes the respective high-resistance resistors 28a, 30a, 28b and 30b is the same number. Each of total resistance value in the high-resistance resistors 28a, 30a, 28b and 30b are the same value, and each resistance value of the low-resistance resistors 32a, 34a, 32b and 34b are the same value. Also, each of the total resistance value (e.g. a few MΩ) in the high-resistance resistors 28a, 30a, 28b and 30b is high enough, compared to each of the total resistance value (e.g. few kΩ) in the low-resistance resistors 32a, 34a, 32b and 34b.

The high-resistance resistors 28a, 30a, 28b and 30b each includes a plurality of resistors so as to secure insulating distance. That is, when a single resistor is used to produce the high-resistance resistor, it is necessary to set the distance between both end terminals to be long enough to keep insulation distance, however, it is difficult to design the resistor to satisfy the distance condition by using only single resistor. As a result, the high-resistance resistor is configured with a plurality of resistors.

The microprocessor 16 further performs discharge control processing. This processing is to discharge the capacitors C1 and C2 under a condition that a conduction path between the high voltage battery 12 and the boost converter CV is cutoff when the relay 14 is opened, thereby preventing any possible danger to securing a safe environment during vehicle maintenance. According to the embodiment, the discharge control processing operates the inverters IV1 and IV2 to allow reactive current to flow in the motor generator 10a and 10b (to enable the motor generator to generate zero torque). As a result, according to the embodiment, the discharge control processing makes the capacitors C1 and C2 discharged quickly.

When the vehicle collides with other vehicle or something, the power conversion system may be damaged. For example, the power source of the microprocessor 16 may be cutoff or a circuit board on which switching elements Swp and Swn are disposed may be broken. Once the power conversion system is damaged, the inverters IV1 and IV2 cannot be operated properly so that discharge control operation cannot be performed.

Considering the above-described emergency situation, according to the embodiment, individual discharge circuits corresponding to the respective capacitors C1 and C2 are arranged in the power conversion system. The discharge circuit is described as follows

A first connection path 36a is provided to connect between the conduction paths 24a and 26a. The first connection path 36a includes a first switching element 38a that opens and closes the first connection path 36a. According to the embodiment, a field effect transistor (FET) is used for the first switching element 38a. More particularly, a depletion type N-channel MOS FET is used for the first switching element. The conduction path 24a is connected to the drain terminal of the first switching element 38a and the conduction path 26a is connected to the source terminal of the first switching element.

A second connection path 36b is provided to connect between the above-described conduction paths 24b and 26b. In the second connection path 36b, a second switching element 38b is disposed to open and close the second connection path 36b. According to the embodiment, a depletion type N-channel MOS FET similar to the one of the first switching element 38a is used for the second switching element 38b. The conduction path 24a is connected to the drain terminal of the second switching element 38b and the conduction path 26b is connected to the source terminal of the conduction path 26b.

According to the embodiment, in the high-resistance resistors 28a and 30a, resistance values of resistors having higher potential (i.e., TH, TN side) than a connection point between the first connection path 36a and the high-resistance resistors 28a or 30a (two resistors are exemplified as shown in FIG. 1) are set to be the same value. Further, each resistance value of the above-described resistors having higher potential is set to be lower than each resistance value of resistors disposed in the lower potential side (i.e., differential amplifier 20a side). That is, when the first switching element 38a is closed, a closed loop circuit (hereinafter referred to first discharge circuit, D1 as shown in FIG. 1) configured with the capacitor C2, a part of high-resistance resistors 28a, the first connection path 36a and a part of high-resistance resistors 30a is produced, and the first connection path 36a is connected between the conduction path 24a and 26a such that the total resistance value (e.g. few kΩ) of a part of the high-resistance resistors 28a and 30a included in the first discharge circuit is set to be lower than the total resistance value (e.g. few MΩ) of the high-resistance resistors 28a and 30a included in the conduction path 24a and the conduction path 26a respectively.

Similarly, in the high-resistance resistors 28b and 30b, resistors having higher potential (i.e., TL, TN side) than a connection point between the second connection path 36b and the high-resistance resistors 28b or 30b (two resistors are exemplified as shown in FIG. 1) are set to be the same value. Further, resistance values of the above-described resistors having higher potential is set to be lower than the resistance value of resistors disposed in the lower potential side (i.e., differential amplifier 20b side). That is, when the first switching element 38b is closed, a closed loop circuit (hereinafter referred to second discharge circuit, D2 as shown in FIG. 1) configured with the capacitor C1, a part of high-resistance resistors 28b, the second connection path 36b and a part of high-resistance resistors 30b is produced, and the second connection path 36b is connected between the conduction path 24b and 26b such that the total resistance value of a part of the high-resistance resistors 28b and 30b included in the second discharge circuit is set to be lower than the total resistance value of the high-resistance resistors 28b and 30b included in the conduction path 24b and the conduction path 26b respectively.

The above-described circuit configuration is to secure a safe environment when in an emergency situation where the power conversion system may be damaged. When the power conversion system is in an emergency situation, fast response is required to secure a safe environment such that voltage of the capacitors C1 and C2 needs to be decreased to below a predetermined low voltage within a short period of time, e.g. a few minutes. To achieve this requirement, the total resistance value of the resistors in the discharge circuit is set to be much lower than respective total resistance values of the high-resistance resistors 28a, 30a, 28b and 30b.

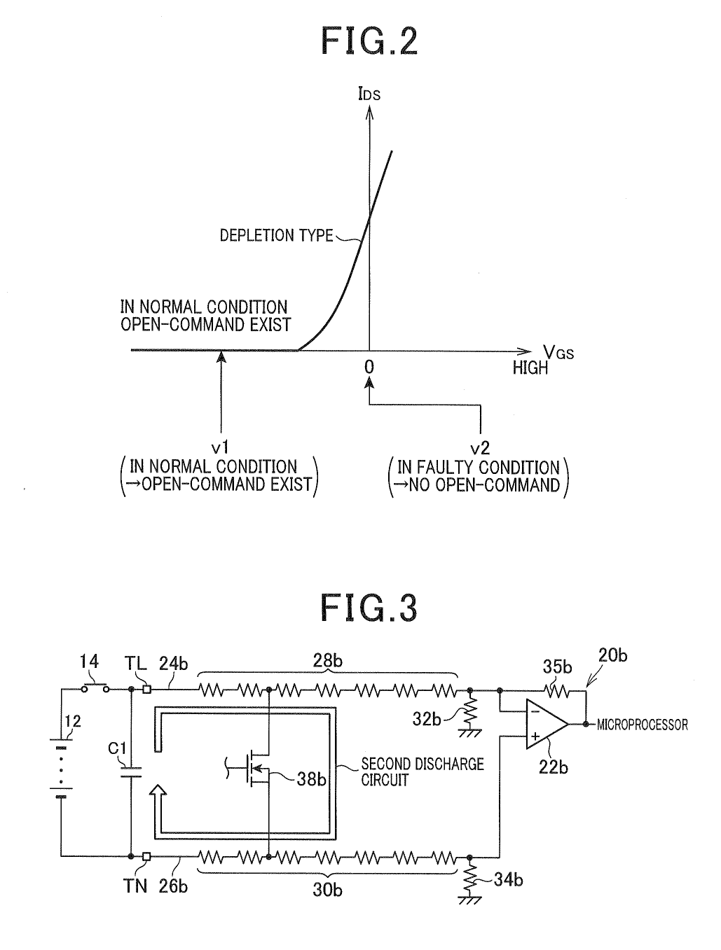

In the above-described discharge circuit, the first switching element 38a and the second switching element 38b serves as a normally On switch. Specifically, as shown in FIG. 2, when the microprocessor 16 outputs a signal commanding the switching elements to be opened (i.e., open signal), the gate voltage VGS of the switching elements decrease to a low enough voltage (v1 as shown in FIG. 2) for the switching element to become open, and when the microprocessor 16 does not output the open signal, the gate voltage VGS of the switching elements is a voltage higher than the voltage v1 (v2 as shown in FIG. 2) and the switching element becomes closed. This setting is to reliably configure the above-described first and second discharge circuits when the power conversion system is in a faulty condition and to reduce the power consumption when the power conversion system is in normal operation.

In other words, when a fault occurs in the power conversion system so that a conduction path between the microprocessor 16 and the power source of the microprocessor 16 is cutoff, the microprocessor 16 cannot switch the first and second switching elements 38a and 38b to be closed whereby the discharge circuit may not be configured. Moreover, assuming the first and second switching elements 38a and 38b are always closed, the first discharge circuit and the second discharge circuit are always configured. Therefore, power of the high voltage battery may be consumed uselessly. To avoid the above-described situation, in the power conversion system, the first and second switching element serve as the normally On switch.

A following configuration can be used to isolate the first and second switching elements 38a and 38b disposed closely to the high voltage system and the microprocessor 16 disposed in the low voltage system, and to operate the switching elements to be normally On.

As shown in FIG. 1, the positive input terminal TH side in the high-resistance resistor 28a and the negative input terminal TN side in the high-resistance resistor 30a are connected with a series-connected body i.e., resistor 40 and the secondary side of a photo coupler 42 (photo transistor). The collector terminal of the photo transistor is connected to the resistor 40 and the emitter terminal is connected to the negative input terminal TN side in the high-resistance resistor 30a. The gate terminal of the first switching element 38a is connected to a connection point between the resistor 40 and the photo transistor.

The primary side of the photo coupler 42 (photo diode) is connected to the microprocessor 16. In more detail, the anode terminal of the photo diode is connected to the microprocessor 16 and the cathode terminal is connected to the ground.

In this configuration, when the microprocessor 16 outputs an open-command to the photo diode (logical High signal), the photo diode turns ON. Since current flows through the resistor 40 when the photo coupler turns ON, the gate voltage of the first switching element 38a decreases due to voltage drop at the resistor 40 so that the gate voltage VGS becomes v1. Therefore, the first switching element 38a becomes opened.

Meanwhile, when some fault occurs in the power conversion system and therefore, the microprocessor cannot output the open-command to the photo diode to set it to the open state, the photo coupler is turned OFF. Since current does not flow through the resistor 40 when the photo coupler turns OFF, no voltage drop at the resistor 40 appears. Hence, the gate voltage of the first switching element 38a increases and the gate voltage VGS becomes v2. Therefore, the first switching element 38a becomes closed.

The configuration in which the second switching element 38b serves as the normally On switch is the same as the configuration for the first switching element 38a. Therefore, configuration of the second switching element 38b is omitted. Moreover, when the current flows through the resistor 40, power is unnecessarily consumed via the resistor 40, so therefore the resistance value of the resistor 40 is preferably set to be larger value as much as possible.

Even when the power conversion system is in a faulty condition, the first and second switching elements may be controlled to be opened or closed by the microprocessor 16. Therefore, for example, when it is determined that the vehicle collides with others based on an output value of an acceleration sensor disposed in the vehicle, by having the microprocessor 16 stop outputting the open-command commanding the first and second switching elements to be open, the first and second switching elements 38a and 38b can be set to the closed state.

Next, with reference to FIG. 3, discharge operation of the capacitor by using the discharge circuit according to the embodiment is described as follows. As shown in FIG. 3, the second discharge circuit is exemplified.

When the power conversion system is in faulty condition, if the second switching element 38b changes to the closed state, the above-described second discharge circuit is configured whereby the capacitor C1 starts discharge.

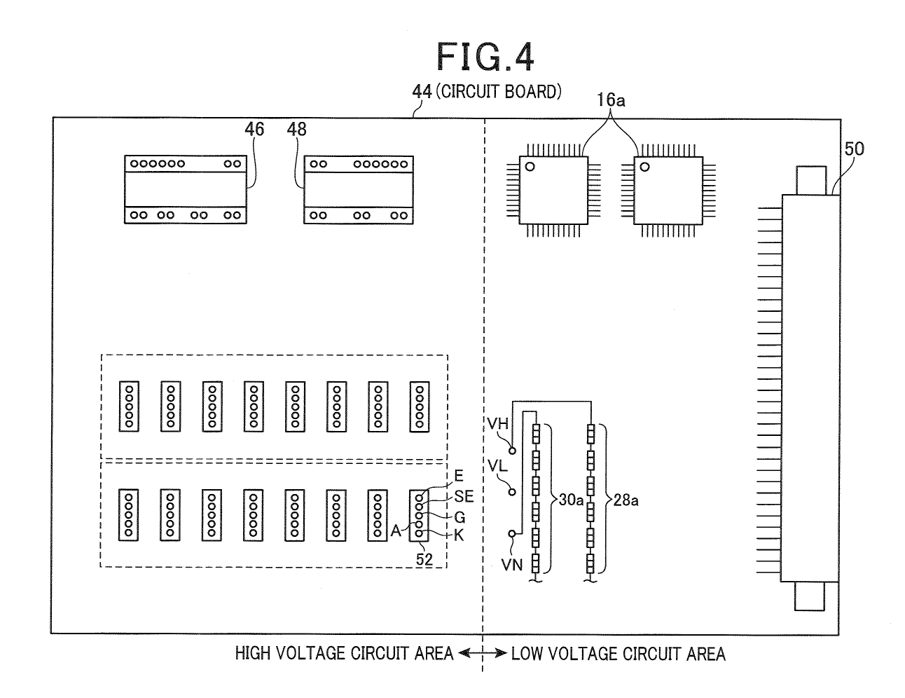

According the embodiment, the differential amplifiers 20a, 20b and the high-resistance resistors are mounted on a circuit board. With reference to FIG. 4, it is described that how the above-described circuit components are mounted on the circuit board as follows.

FIG. 4 illustrates the circuit board (i.e., printed circuit board) on which the differential amplifiers and the high-resistance resistors are mounted according to the embodiment.

The circuit board 44 as shown in FIG. 4 is provided with a low voltage circuit area where a central processing unit (CPU16a) included in the microprocessor 16 are disposed and a high voltage circuit area being connected to the inverters IV1, IV2 and the boost converter CV. As shown in FIG. 4, the right area corresponds to the low voltage circuit area and the left area corresponds to the high voltage circuit area. However, circuit components such as the photo coupler that configure both the low voltage system and the high voltage system are mixed in the high voltage circuit area. Also, transformers 46 and 48 configuring both low voltage system and the high voltage system, used for a flyback converter which is a power source of a drive circuit for driving each of the switching elements Swp and Swn included in the inverters IV1, IV2 and the boost converter CV, are disposed in the high voltage circuit area (left side area as shown in FIG. 4).

As shown in FIG. 4, the connector 50 is used for grounding of the low voltage system (i.e., vehicle-body), a power line of the low voltage battery of which terminal voltage ranges from 10 to 20 volts, and for connecting the communication line such as CAN (control area network) communication line to the low voltage circuit area on the circuit board 44. The CPU 16a receives a control signal representing control commands, e.g. a torque command from an external controller i.e., electronic control unit (ECU) via the connector 50. The control commands are used for controlling the first motor generator 10a or the second motor generator 10b.

The respective switching elements of the above-described inverters IV1, 1V2 and the boost converter CV are inserted into a connecting portion 52 arranged on the circuit board 44 from the back side of the circuit board 44 (back side of a plane as shown in FIG. 4) thereby making a connection between the switching elements and the circuit board 44.

Regarding the switching elements, each of the switching elements Swp and Swn is accommodated in a power card (not shown) to be packaged. The power card is inserted into the connecting portion 52 to be connected with the circuit board 44 such that a kelvin emitter terminal E, a sense terminal SE, a control terminal (gate G), and an anode A terminal and a cathode K terminal of the temperature sensing diode of the power card is inserted into a plurality of connecting portions 52 arranged on the circuit board 44 (as shown in FIG. 4). The kelvin emitter terminal E has the same potential as the emitter terminal of the switching elements Swp and Swn. The sense terminal SE is a terminal to output a small amount of current that correlates to current flowing through the switching elements Swp and Swn.

According to the embodiment, the positive input terminal TH, the battery positive input terminal TL and the negative input terminal TN are disposed in the low voltage circuit area. The high-resistance resistor 28a connected to the positive input terminal TH and the high-resistance resistor 30a connected to the negative input terminal TN are mounted on the low voltage circuit area. Moreover, the high-resistance resistor 28b connected to the battery positive input terminal TL and the differential amplifier and the like are mounted on the back side of the circuit board 44.

The reason why the high-resistance resistor can be mounted on the circuit board 44 is that the discharge circuit of the capacitor is not configured when the power conversion system is in normal operation and the high-resistance resistor does not generate heat.

However, in a circuit configuration where the discharge circuit of the capacitor is always configured, the high-resistance resistor generates heat. Hence, it would be difficult to mount the high-resistance resistor on the circuit board. As a result, a flexibility of layout design for the high-resistance resistor would be restricted.

According to the embodiment, the following advantages can be obtained.

(1) The first connection path 36a (second connection path 36b) connects the conduction paths 24a and 26a (24b, 26b). Specifically, when the first switching element 38a (second switching element 38b) is in a closed state, the first connection path 36a (second connection path 36b) connects the conduction path 24a and 26a (24b and 26b) so as to include a part of high-resistance resistors 28a and 30a (28b, 30b) in the first discharge circuit (second discharge circuit) including the capacitor C2 (C1), a part of high-resistance resistor 28a (28b), the first connection path 36a (second connection path 36b) and a part of high-resistance resistor 30a (30b).

Therefore, the high-resistance resistor used for detecting voltage in the power converting system can be used for a discharge resistor. For example, compared to a circuit configuration in which resistors for discharging capacitor is disposed via wire harness, the number of circuit components necessary for disposing the discharge circuit used for the capacitor can be reduced. As a result, size of the power conversion system provided with the discharge circuit can be reduced so that increasing manufacturing cost can be suppressed as well.

(2) When the first switching element 38a (second switching element 38b) is closed state, the first connection path 36a connects the conduction paths 24a and 26a (24b, 26b) such that the total resistance value of the high-resistance resistors 28a and 30a (28b, 30b) included in the first discharge circuit (second discharge circuit) is set to be smaller than the total resistance of the high-resistance resistors 28a and 30a (28b, 30b) arranged in the conduction paths 24a and 26a (24b, 26b) respectively. According to this configuration, accuracy for detecting the voltage by the differential amplifiers 20a and 20b can be secured and the capacitor can be appropriately discharged.

(3) The discharge circuits are disposed for capacitors C1 and C2 individually, whereby the capacitors C1 and C2 can be discharged promptly.

(4) The first switching element 38a and the second switching element 38b serve as normally On switches. Hence, even if the power conversion system is in a faulty condition a discharge path of the capacitor C1 (C2) can be appropriately secured.

Furthermore, according to the above-described configuration, the first switching element 38a and the second switching element 38b are in an open state when the power conversion system is in normal condition so that the discharge circuit is not configured all the time. Accordingly, the above-described configuration can reduce power consumption due to the current flowing from the high voltage battery 12 to the resistors in the discharge circuit when the discharge circuit is configured. Further, heat generated at the resistors can be suppressed whereby flexibility of the design regarding a layout of the high-resistance resistors (discharge resistors) can be enhanced, for example, the high-resistance resistors can be mounted on the circuit board 44.

### Second Embodiment

With reference to the drawings, hereinafter is described the second embodiment wherein the differences between the above-described first embodiment and the second embodiment is mainly described.

FIG. 5 is a block diagram showing a system configuration according to the second embodiment. Regarding components in FIG. 5 which is the same as the components as shown in FIG. 1, the same reference numbers are applied.

As shown in FIG. 5, the microprocessor 16 outputs operation signals via an interface device 18 in order to operate the switching elements of the boost converter CV and the inverters IV1 and IV2. The microprocessor 16 outputs the operation signals to the drive unit Dup corresponding to the high side switching elements of the respective units (boost converter CV and the inverters IV1 and IV2) and the drive unit Dun corresponding to the low side switching elements of the respective units.

The drive units Dup and Dun are disposed in the high voltage system and each includes a drive IC which is a one chip semiconductor integrated circuit. According to the second embodiment, the reference voltage of the drive unit Dup corresponding to the upper arm is a voltage at the emitter side of the high side switching element Swp, and the reference voltage of the drive unit Dun corresponding to the lower arm is a voltage at the emitter side of the low side switching element Swn (voltage VN at the negative input terminal TN).

The above-described discharge control processing operates the switching element via the drive unit that corresponds to either inverter IV1 or IV2 having the switching element to be operated. It is noted that only drive units corresponding to the switching element included in the boost converter CV is shown in FIG. 5. However, other drive units corresponding to the inverter IV1 or IV2 are arranged in the power conversion system as well.

Next, the discharge circuit according to the second embodiment is described as follows.

A connection point which is located adjacent to the positive input terminal TH side (the first connection point from the TH side) among connection points where respective high-resistance resistors 28a are mutually connected in series, and the negative input terminal TN side in the high-resistance resistors 30a, are connected by the first connection path 44a. In the first connection path 44a, a first switching element 46a that opens and closes this connection path 44a is disposed. The first switching element 46a is a depletion type N-channel MOS FET similar to the switching elements 38a and 38b in the first embodiment. A conduction path 24a is connected to the drain terminal of the first switching element 46a and a conduction path 26a is connected to the source terminal of the switching element 46a.

On the other hand, a connection point which is located adjacent to the battery positive input terminal TL side among connection points where respective high-resistance resistors 28b are mutually connected in series, and the negative input terminal TN side in the high-resistance resistors 30b, are connected by the first connection path 44a. In the second connection path 44b, a second switching element 46b that opens and closes this connection path 44b is disposed. The second switching element 46b is a depletion type N-channel MOS FET as similar to the first switching element 46a.

The gate voltage VGS of these first switching element 46a and the second switching element 46b is controlled by the drive unit Dun corresponding to the lower arm.

In this configuration, when the microprocessor 16 outputs an open-command to the drive unit (when a discharge command is not outputted), the gate voltages of the first and second switching elements are decreased. Then, the gate voltage VGS becomes voltage v1 (see FIG. 2). Therefore, the first switching element 46a and the second switching element 46b become open.

When the power conversion system is in a faulty condition so that the microprocessor 16 does not output the open-command to the drive unit Dun (i.e., discharge command is outputted), the drive unit Dun controls the gate terminals of the first switching element 46a and the second switching element 46b to be applied with voltage VN which is the reference voltage of the drive unit Dun whereby the gate voltages of the first and second switching elements are increased. Then, the gate voltage VGS becomes voltage v2 (see FIG. 2). Therefore, the first switching element 46a and the second switching element 46b become closed.

Thus, according to the second embodiment, the reference voltage VN of the drive unit Dun corresponding to the lower arm is applied to the gate terminals of the first and second switching elements 46a and 46b when the microprocessor 16 does not output the open-command to the drive unit Dun. As a result, circuit configuration in which the first switching elements 46a and the second switching elements 46b are controlled to be closed when the power conversion system is in faulty condition can be simplified.

### Other Embodiments

The above-described embodiments can be modified as follows. In the above-described embodiments, the discharge circuits are individually provided for the respective capacitors C1 and C2, however, it is not limited to this circuit configuration. For example, the discharge circuit can be disposed for either capacitor C1 or capacitor C2.

In the above-described embodiments, assuming the reference voltage level of the high voltage system equals to the ground potential of the low voltage system, it is not necessary to divide the voltage by using the high-resistance resistors 30a and 30b and the low resistance resistors 32a and 32b in the differential amplifier 20a and 20b. Hence, these resistors 30a, 30b, 32a and 32b can be excluded from the circuit configuration.

To detect voltage difference between the positive input terminal TH, the battery positive input terminal TL and the negative input terminal TN is not limited to a circuit configuration using the differential amplifiers as described in the above-described embodiments. For example, voltage between the pair of input terminal of the operational amplifier 22a and 22b as shown in FIG. 1 may be connected to the input terminals of the microprocessor 16 directly, then the microprocessor 16 detects the voltage difference based on the voltage between the pair of input terminal.

The power conversion circuit disposed in the power conversion system is not limited to the circuit configuration including the pair of inverters IV1 and IV2, and the boost converter CV. For example, only inverters IV1 and IV2 may be disposed in the power conversion system. Moreover, when the power conversion system includes a single rotary electric machine as an on-vehicle main unit, only one inverter unit can be disposed in the power conversion system.

According to the above-described embodiments, in the high-resistance resistors 28a, a resistance value of the high-resistance resistor disposed at high potential side with respect to the connection point of the first connection path 36a and a resistance value of the high-resistance resistor disposed at low potential side with respect to the connection point are set to be different value. However, all resistors that constitute the high-resistance resistors 28a may have the same resistance value. In this case, even the discharge rate of the capacitor decreases by increase of the resistance value, it is not necessary to use various types of resistors. Therefore, a conventional system for detecting input voltage of the inverter can be used for the power conversion system according to the above-described embodiments. Similarly, the above-described configuration is adapted to other high-resistance resistors 30a, 28b and 30b.

Regarding the series-connected resistors used for a voltage divider which is disposed in the conduction path, it is not limited to the above-described plurality of resistors connected in series. However, for example, a pair of resistors connected in parallel can be used such that a plurality of pair of resistors are mutually connected in series. This configuration is employed to radiate the heat generated at the resistors.

As an inverter circuit (DC to AC converting circuit), it is not limited to an inverter connected to a rotary electric machine that is mechanically connected to a drive shaft of the vehicle. For example, an inverter connected to a rotary electric machine integrated in a compressor used for an air conditioner that is directly powered by the high voltage battery 12. Moreover, instead of the inverter circuit, a DC to DC converter that generates voltage stepped-down from the high voltage battery 12 and outputs the stepped down voltage to a battery in the low voltage system can be used.

As to the vehicle to which the power conversion system according to the present application is adapted, it is not limited to the parallel series hybrid vehicle, however, vehicles having no internal combustion engine as an on-vehicle main unit such as an electric vehicle or a fuel-cell vehicle may be employed.

What is claimed is:

1. A discharge circuit for discharging a capacitor disposed in a system comprising a DC power source, a power conversion circuit and a voltage detecting circuit, the power conversion circuit being connected to the DC power source via a pair of input terminals included in the power conversion circuit, the capacitor being connected to the pair of input terminals, the voltage detecting circuit detecting voltage between the pair of input terminals, the discharge circuit comprising:
a pair of conduction paths that connect between the power conversion circuit and the pair of input terminals;
a series-connected resistor having a plurality of resistors connected in series, disposed in the conduction path, dividing a voltage difference between the input terminal and a reference voltage;
a connection path that connects between the pair of conduction paths;
switching means for switching the connection path to be opened and closed, switching means being disposed in the connection path; and
control means for controlling the switching means such that the connection path is opened or closed, the control means controlling the switching means to have the connection path closed so as to make a closed loop circuit including the capacitor and the connection path,
wherein the connection path is disposed between the pair of conduction paths to include at least one resistor of the plurality of resistors in the closed loop circuit when the switch is closed by the control unit.

2. The discharge circuit according to claim 1, wherein
the connection path is disposed in the pair of conduction paths such that total resistance value of the at least one resistor of the plurality of resistors included in the closed loop circuit is smaller than total resistance value of the plurality of resistors of the series-connected resistor.

3. The discharge circuit according to claim 1, wherein
the power conversion circuit includes a boost converter that boosts voltage at the DC power source connected thereto and outputs the voltage boosted by the boost converter; and a DC to AC converting circuit connected to an output of the boost converter, the capacitor being connected individually between the pair of input terminals disposed in the boost converter and the pair of input terminals disposed in the DC to AC converting circuit, and the voltage detecting circuit is arranged to be dedicated to both the boost converter and the DC to AC converting circuit individually.

4. The discharge circuit according to claim 2, wherein
the power conversion circuit includes a boost converter that boost voltage at the DC power source connected thereto and outputs the voltage boosted by the boost converter; and a DC to AC converting circuit connected to an output of the boost converter, the capacitor is connected individually between the pair of input terminals disposed in the boost converter and the pair of input terminals disposed in the DC to AC converting circuit, and the voltage detecting circuit is arranged to be dedicated to both the boost converter and the DC to AC converting circuit individually.

5. The discharge circuit according to claim 1, wherein the control unit is configured to output an operation signal that controls the switch to be opened or closed, the switch being controlled to be opened when the control unit outputs the operation signal and controlled to be closed when the control unit does not output the operation signal.

6. The discharge circuit according to claim 2, wherein the control unit is configured to output an operation signal that controls the switch to be opened or closed, the switch being controlled to be opened when the control unit outputs the operation signal and controlled to be closed when the control unit does not output the operation signal.

7. The discharge circuit according to claim 3, wherein the control unit is configured to output an operation signal that controls the switch to be opened or closed, the switch being controlled to be opened when the control unit outputs the operation signal and controlled to be closed when the control unit does not output the operation signal.

8. A system for converting power comprising:
a DC power source;
a power conversion circuit connected to the DC power source via a pair of input terminals included in the power conversion circuit, the power conversion circuit converting power of the DC power source;
a voltage detecting circuit that detects voltage between the pair of input terminals;
a capacitor connected to the pair of input terminals; and a discharging circuit for discharging the capacitor, the discharging circuit including:
a pair of conduction paths that connect between the power conversion circuit and the pair of input terminals;
a series-connected resistor having a plurality of resistors connected in series, disposed in the conduction path, dividing a voltage difference between the input terminal and a reference voltage;
a connection path that connects between the pair of conduction paths;
a switch disposed in the connection path, which opens and closes the connection path, the switch being controlled electrically; and
a control unit that controls the switch to be opened or closed, the control unit controlling the switch to make a closed loop circuit including the capacitor and the connection path,
wherein the connection path is disposed between the pair of conduction paths to include at least one resistor of the plurality of resistors in the closed loop circuit when the switch is closed by the control unit.

9. The system according to claim 8, wherein
the connection path is disposed in the pair of conduction paths such that total resistance value of the at least one resistor of the plurality of resistors included in the closed loop circuit is smaller than total resistance value of the plurality of resistors of the series-connected resistor.

10. The system according to claim 8, wherein
the power conversion circuit includes a boost converter that boost voltage at the DC power source connected thereto and outputs the voltage boosted by the boost converter; and a DC to AC converting circuit connected to an output of the boost converter, the capacitor is connected individually between the pair of input terminals disposed in the boost converter and the pair of input terminals disposed in the DC to AC converting circuit, and the voltage detecting circuit is arranged to be dedicated to both the boost converter and the DC to AC converting circuit individually.

11. The system according to claim 8, wherein the control unit is configured to output an operation signal that controls the switch to be opened or closed, the switch is controlled to be opened when the control unit outputs the operation signal and controlled to be closed when the control unit does not output the operation signal.
